(19) United States
(12) Patent Application Publication
(10) Pub. No.: US 2025/0146141 A1
(43) Pub. Date: May 8, 2025

(54) Hybrid Electrochemical Method and System for Syngas Production

(71) Applicant: FuelCell Energy, Inc., Danbury, CT (US)

(72) Inventors: Pascal Tessier, Ridgefield, CT (US); Joseph M. Daly, Bethel, CT (US); Joseph Barton, Danbury, CT (US); Maxwell James Steffen Cameron-Jones, Hoboken, NJ (US)

(21) Appl. No.: 18/934,584

(22) Filed: Nov. 1, 2024

Related U.S. Application Data
(60) Provisional application No. 63/596,399, filed on Nov. 6, 2023.

(51) Int. Cl. C25B 1/042; C25B 15/021; C25B 15/08; H01M 8/14

(52) U.S. Cl. CPC C25B 1/042; C25B 15/081; H01M 8/14; C25B 15/021; H01M 2008/147; H01M 2250/00

(57) ABSTRACT

A syngas generation system includes a molten carbonate fuel cell (MCFC) including a MCFC cathode configured to receive a MCFC cathode input stream including a flue gas stream and a MCFC anode configured to output a MCFC anode exhaust stream including carbon dioxide and steam. The syngas generation system further includes a solid oxide electrolysis cell (SOEC) including an SOEC cathode and an SOEC anode. The SOEC is configured to receive, at the SOEC cathode, an SOEC cathode input stream, the SOEC cathode input stream including at least a portion of the MCFC anode exhaust stream, co-electrolyze carbon dioxide and steam in the SOEC cathode input stream, and output, from the SOEC cathode, an SOEC cathode exhaust stream including carbon monoxide and hydrogen gas.

### CROSS-REFERENCE TO RELATED APPLICATIONS

This application claims the benefit of and priority to U.S. Provisional Patent Application No. 63/596,399, filed Nov. 6, 2023, which is incorporated by reference herein in its entirety.

### BACKGROUND

The present invention relates generally to the field of syngas production.

Syngas, also known as synthesis gas, is a gas mixture containing primarily hydrogen and carbon monoxide, in various ratios. Syngas is used in a variety of industrial processes, including the production of ammonia, methanol, and synthetic fuels, including aircraft fuel. For example, the Fischer-Tropsch process is commonly used to convert syngas to hydrocarbons for use as synthetic fuels and oils.

Syngas is typically manufactured by steam reforming or partial oxidation of natural gas or liquid hydrocarbons, or by coal gasification. These are energy-intensive processes that also result in the production of pollutants and greenhouse gases, including carbon dioxide. Syngas can also be produced from a stream containing carbon dioxide by separating the carbon dioxide from the stream, for example, using a membrane separator or by cooling and liquifying the carbon dioxide, generating a hydrogen stream, mixing the hydrogen and carbon dioxide, and performing a reverse water-gas shift reaction to shift the carbon dioxide to carbon monoxide. This is again an energy-intensive process that requires numerous pieces of equipment and process steps.

Accordingly, it would be beneficial to provide a method of producing syngas that requires less energy and equipment and generates fewer pollutants and greenhouse gases.

### SUMMARY

In one aspect, the present disclosure describes a syngas generation system. The syngas generation system includes a molten carbonate fuel cell (MCFC) including a MCFC cathode configured to receive a MCFC cathode input stream including a flue gas stream and a MCFC anode configured to output a MCFC anode exhaust stream including carbon dioxide and steam. The syngas generation system further includes a solid oxide electrolysis cell (SOEC) including an SOEC cathode and an SOEC anode. The SOEC is configured to receive, at the SOEC cathode, an SOEC cathode input stream, the SOEC including at least a portion of the MCFC anode exhaust stream co-electrolyze carbon dioxide and steam in the SOEC cathode input stream, and output, from the SOEC cathode, an SOEC cathode exhaust stream including carbon monoxide and hydrogen gas.

In some embodiments, the syngas generation system further includes a controller configured to control a flow rate of additional steam into the SOEC cathode input stream. In some embodiments, the controller is configured to control the flow rate of additional steam based on a predetermined target ratio of carbon monoxide to hydrogen gas in the SOEC cathode exhaust stream.

In some embodiments, the SOEC is configured to receive electrical power produced by the MCFC.

In some embodiments, the syngas generation system further includes a methanation reactor configured to receive a portion of the MCFC anode exhaust stream, methanate the portion of the MCFC anode exhaust stream, and output a methanated exhaust stream to the MCFC anode. In some embodiments, the methanation reactor is further configured to receive and methanate a first portion of the SOEC cathode exhaust stream. In some embodiments, the SOEC cathode input stream further includes a second portion of the SOEC cathode exhaust stream.

In some embodiments, the SOEC anode is configured to output an SOEC anode exhaust stream including oxygen gas, the syngas generation system further including a gasifier configured to, receive at least a first portion of the SOEC anode exhaust stream, gasify biomass using the SOEC anode exhaust stream, and output a gasified exhaust stream to the MCFC anode. In some embodiments, the MCFC cathode input stream includes a portion of the MCFC anode exhaust stream. In some embodiments, the SOEC anode is configured to receive a second portion of the SOEC anode exhaust stream.

In some embodiments, the SOEC is configured to receive heat generated by the MCFC

In another aspect, the present disclosure describes a method of producing syngas using a molten carbonate fuel cell (MCFC) and a solid oxide electrolysis cell (SOEC). The method includes supplying a flue gas stream to a MCFC cathode of the MCFC, the MCFC configured to output a MCFC anode exhaust stream including carbon dioxide and steam from an MCFC anode. The method further includes supplying an SOEC cathode input stream to an SOEC cathode of the SOEC, the SOEC cathode input stream including at least a portion of the MCFC anode exhaust stream. The SOEC is configured to co-electrolyze carbon dioxide and steam in the SOEC cathode input stream and to output an SOEC cathode exhaust stream including carbon monoxide and hydrogen gas.

In some embodiments, the method further incudes supplying additional steam to the SOEC cathode input stream. In some embodiments, an amount of the additional steam supplied to the SOEC cathode exhaust stream is determined based on a predetermined target ratio of carbon monoxide to hydrogen gas in the SOEC cathode exhaust stream.

In some embodiments, the method further incudes supplying power generated by the MCFC to the SOEC.

In some embodiments, the method further incudes methanating a portion of the MCFC anode exhaust stream and supplying methanated exhaust to the MCFC anode. In some embodiments, the method further incudes methanating a first portion of the SOEC cathode exhaust stream, the methanated exhaust incuding methanated SOEC cathode exhaust. In some embodiments, the method further incudes supplying a second portion of the SOEC cathode exhaust stream to the SOEC cathode input stream.

In some embodiments, the method further incudes gasifying biomass using at least a first portion of an SOEC anode exhaust stream from an SOEC anode of the SOEC and supplying a gasified exhaust stream to the MCFC anode. In some embodiments, the method further incudes supplying a portion of the MCFC anode exhaust stream to the MCFC cathode. In some embodiments, the method further incudes supplying a second portion of the SOEC anode exhaust stream to the SOEC anode.

In some embodiments, the method further incudes supplying heat generated by the MCFC to the SOEC.

In another aspect, the present disclosure describes a syngas generation system. The syngas production system includes a molten carbonate fuel cell (MCFC) including a MCFC cathode and an MCFC anode configured to output a MCFC anode exhaust stream including carbon dioxide, a solid oxide electrolysis cell (SOEC) including an SOEC anode and an SOEC cathode configured to output an SOEC cathode exhaust stream including hydrogen gas, and a reverse water-gas shift reactor (RWGSR) configured to receive a RWGSR input stream including at least a portion of the MCFC anode exhaust stream and at least a portion of the SOEC cathode exhaust stream, the RWGSR configured to output a RWGSR output stream including hydrogen and carbon monoxide.

In some embodiments, the syngas generation system further includes a controller configured to control a first flow rate of the at least the portion of the MCFC anode exhaust stream and a second flow rate of the at least the portion of the SOEC cathode exhaust stream into the RWGSR input stream. In some embodiments, the controller is configured to control the first flow rate and the second flow rate based on a predetermined target ratio of carbon monoxide to hydrogen gas in the RWGSR output stream.

The foregoing is a summary of the disclosure and thus by necessity contains simplifications, generalizations, and omissions of detail. Consequently, those skilled in the art will appreciate that the summary is illustrative only and is not intended to be in any way limiting. Other aspects, features, and advantages of the devices and/or processes described herein, as defined by the claims, will become apparent in the detailed description set forth herein and taken in conjunction with the accompanying drawings.

### BRIEF DESCRIPTION OF THE DRAWINGS

FIGS. 1-6 are schematic diagrams of syngas production systems, according to various exemplary embodiments.

It will be recognized that the figures are schematic representations for purposes of illustration. The figures are provided for the purpose of illustrating one or more implementations with the explicit understanding that the figures will not be used to limit the scope of the meaning of the claims.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

According to an exemplary embodiment, syngas may be manufactured by supplying anode exhaust from a molten carbonate fuel cell (MCFC) to the cathode of a solid oxide electrolysis cell (SOEC). In the process, carbon dioxide from a flue gas may be captured and used to produce carbon monoxide. The anode exhaust from the MCFC may contain high levels of carbon dioxide and water (steam). The SOEC may be configured to perform co-electrolysis, or the simultaneous electrolysis of steam and carbon dioxide. In the cathode of the SOEC, the carbon dioxide is reduced to carbon monoxide gas and oxide ions, and the steam is reduced to hydrogen gas and oxide ions. The oxide ions cross over the electrolyte of the SOEC to the anode and are released as oxygen gas, while a mixture of the carbon monoxide gas and the hydrogen gas (e.g., syngas) is discharged from the cathode. This process may result in fewer carbon dioxide and pollutant emissions and may require less energy and equipment than conventional syngas production methods. A flow rate of additional steam to the SOEC may be controlled in order to adjust the ratio of hydrogen to carbon monoxide in the syngas stream discharged from the cathode of the SOEC.

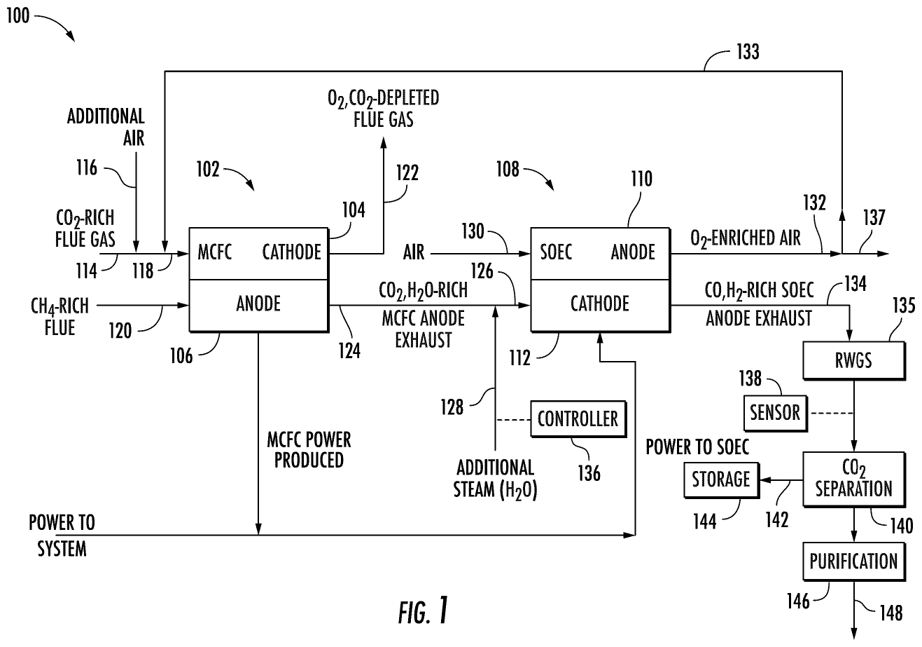

Referring to FIG. 1, a syngas production system 100 is shown, according to some embodiments. Syngas production system 100 includes a MCFC 102 and an SOEC 108. The MCFC 102 includes a MCFC cathode 104 and a MCFC anode 106. The MCFC cathode 104 and the MCFC anode 106 are separated by an electrolyte configured to transport carbonate ions from the cathode to the anode. It should be understood that the MCFC 102 may include a single fuel cell or multiple fuel cells (which may be arranged in one or more stacks and one or more modules).

The SOEC 108 includes an SOEC anode 110 and an SOEC cathode 112. The SOEC anode 110 and an SOEC cathode 112 are separated by an electrolyte configured to transport oxide ions from the SOEC cathode 112 to the SOEC anode 110. It should be understood that the SOEC 108 may include one electrolysis cell or multiple electrolysis cells (which may be arranged in one or more stacks and one or more modules).

A flue gas stream 114 containing a significant amount of carbon dioxide may be supplied to the MCFC cathode 104. For example, the carbon dioxide concentration in the flue gas stream 114 may be between about 4 percent and 9 percent, or between 2 percent and 11 percent. The flue gas stream 114 may be generated from a variety of sources, such as industrial manufacturing plants and fossil fuel power plants. An additional air stream 116 may be mixed with the flue gas stream 114 before the flue gas stream 114 is supplied to the MCFC cathode 104. The additional air stream 116 provides additional oxygen that reacts with the carbon dioxide in the MCFC cathode 104 to form carbonate ions, as discussed below. The gas stream supplied to the MCFC cathode 104, including the flue gas stream 114 and the additional air stream 116, may be referred to as a MCFC cathode input stream 118. In the MCFC cathode 104, carbon dioxide, oxygen, and electrons received from the MCFC anode 106 via an external circuit form carbonate ions according to the formula:

½ O₂+CO₂+2e⁻→CO₃⁼

The carbonate ions are then transported across the electrolyte from the MCFC cathode 104 to the MCFC anode 106.

While the MCFC cathode input stream 118 is supplied to the MCFC cathode 104, a MCFC anode input stream 120 may be supplied to the MCFC anode 106. The MCFC anode input stream 120 may include a methane-rich fuel and/or hydrogen gas. In the anode, the methane may undergo a reforming reaction to form hydrogen gas and carbon monoxide. In some embodiments, system 100 may include an external reformer configured to reform the flue gas stream 114 or the MCFC cathode input stream 118. In some embodiments, the MCFC anode 106 may include reforming catalyst and the MCFC cathode input stream 118 may be reformed within the MCFC anode 106 (e.g., internal reforming). The carbon monoxide produced from the reforming reaction may undergo a water-gas shift reaction and be converted to carbon dioxide. The net reaction of the reforming and water-gas shift may be the following:

CH₄+2H₂O→4H₂+CO₂.

The hydrogen gas formed from the reforming and water-gas shift reactions may then be oxidized to hydrogen ions, which react with the carbonate ions transported across the electrolyte from the MCFC cathode to form water vapor and carbon dioxide. As a result of the reaction, electrons will be released, which as discussed above, may travel through the external circuit to the MCFC cathode 104, generating an electrical current. The reaction of the hydrogen and carbonate ions in the MCFC anode 106 may be described according to the following formula:

4H₂+4CO₃⁼→4H₂O+4CO₂+8e⁻

Thus, there are two sources of carbon dioxide in the anode exhaust: the carbon dioxide in the flue gas, which is transferred as carbonate anion in the electrochemical reaction, and the carbon dioxide from the reforming of the methane or other hydrocarbon fuel. The water vapor and carbon dioxide may then be exhausted from the MCFC anode 106 in an MCFC anode exhaust stream 124. In effect, carbon dioxide in the flue gas stream 114 is separated from the other gases in the MCFC cathode 104 and transported to the MCFC anode 106. The MCFC cathode 104 outputs a MCFC cathode exhaust stream 122 with a lower level of carbon dioxide than the MCFC cathode input stream 118. In some embodiments, the MCFC cathode exhaust stream 122 may be vented to the atmosphere, directed to another system, or stored for later use. In addition to the carbon dioxide-forming reaction discussed above, the hydrogen and carbonate ions may react to form carbon monoxide in the MCFC anode 106, according to the formula:

2H₂+CO³⁻→2H₂O+CO+e⁻

The MCFC anode exhaust stream 124 may thus include carbon monoxide in addition to carbon dioxide and hydrogen.

The MCFC anode exhaust stream 124 may be directed to the SOEC cathode 112 via the SOEC cathode input stream 126. In some embodiments, an additional steam stream 128 may be mixed with the MCFC anode exhaust stream 124 to form the SOEC cathode input stream 126. An external current may be supplied to the SOEC 108, and the steam and carbon dioxide in the SOEC cathode input stream 126 may each be electrolyzed (i.e., co-electrolysis). In the SOEC cathode 112, steam may be reduced to hydrogen and oxide ions, and the carbon dioxide may be reduced to carbon monoxide and oxide ions according to the following formulas:

H₂O+2e⁻→H₂+O⁼

CO₂+2e⁻→CO+O⁼

The oxide ions are transported across the electrolyte to the SOEC anode and oxidized to oxygen gas. An SOEC anode input stream 130 including air may be supplied to the SOEC anode 110 and may mix with the oxygen gas in the SOEC anode 110, diluting the substantially pure oxygen gas and sweeping it out of the SOEC anode 110. The air and oxygen mixture (or oxygen-enriched air) may be output from the SOEC anode 110 as an SOEC anode exhaust stream 132. The carbon monoxide and hydrogen mixture (e.g., syngas) produced in the SOEC cathode 112 is then output from the SOEC cathode 112 as an SOEC cathode exhaust stream 134 (which may be referred to as a syngas stream 134). Carbon monoxide may also be formed by reverse water-gas shift (RWGS) reaction within the SOEC cathode 112 according to the formula:

CO₂+H₂→CO+H₂O.

It is known that both the RWGS reaction and the electrolysis of carbon dioxide are possible and their relative rates depend on operating parameters such as the relative gas concentrations in the SOEC cathode 112. The term “co-electrolysis,” as used herein, encompasses the combination of the electrochemical reduction of carbon dioxide and the RWGS reaction occurring in the SOEC cathode 112 in addition to the electrochemical reduction of water.

Some or all of the SOEC anode exhaust stream 132, which contains oxygen-enriched air, may be mixed with the flue gas stream 114 in addition to or instead of the additional air stream 116 and input into the MCFC cathode 104 as the MCFC cathode input stream 118. The oxygen-enriched air may be returned to the input side of the MCFC cathode via a return stream 133 to be mixed with the flue gas stream 114. The remainder of the SOEC anode exhaust stream 132 may be exhausted from the system 100 via exhaust line 137. Because the SOEC anode exhaust stream 132 (oxygen-enriched air) has a higher concentration of oxygen (and therefore a lower concentration of nitrogen) than the air in the additional air stream 116, the MCFC cathode input stream 118 may be less diluted by nitrogen. This may increase the operating voltages of the MCFC 102, thus increasing the power production and current density of the MCFC 102.

System 100 may include a controller 136 configured to control the flow rate of additional steam. For example, the controller 136 may control an actuator configured to open and close a valve to allow the additional steam to flow therethrough or may control the speed of a blower configured to blow additional steam toward the SOEC cathode input stream 126. By controlling the amount of steam supplied via the additional steam stream 128, the ratio of hydrogen to carbon monoxide in the syngas stream 134 may be controlled. For example, adding more steam to the SOEC cathode input stream 126 may increase the proportion of hydrogen in the syngas stream 134. In some embodiments, system 100 may include at least one sensor 138 communicatively coupled to the controller 136 and configured to measure the hydrogen and carbon monoxide levels in the syngas stream 134. The controller 136 may adjust the amount of additional steam supplied based on the measurements from the at least one sensor 138 in order to achieve a predetermined or target ratio of hydrogen to carbon monoxide in the syngas stream 134. In some embodiments, additional hydrogen gas (e.g., from a hydrogen pipeline or storage, a PEM electrolyzer, or another SOEC) may be added to the syngas stream 134 to increase the ratio of hydrogen to carbon monoxide. Without the addition of steam to the SOEC cathode input stream 126 or the addition of hydrogen to the syngas stream 134, the ratio of hydrogen to carbon monoxide in the syngas stream 134 may be between about 1:3 to about 1:6, which may be lower than needed for some industrial applications. In some embodiments, electricity generated by the MCFC 102 may be used to power the SOEC 108, either alone or in combination with another power source. In some embodiments, heat generated by the net exothermic reactions of the MCFC 102 may be supplied to the SOEC 108, in which the reactions are net endothermic.

In some embodiments, the syngas stream 134 may be directed to a reverse water-gas shift reactor 135, where carbon dioxide remaining in the syngas stream 134 may be shifted to carbon monoxide in a reverse water-gas shift reaction. The reverse water-gas shift reaction also converts some of the hydrogen gas to water vapor. As discussed above, additional hydrogen gas may be mixed with the syngas stream 134 to increase the ratio of hydrogen to carbon monoxide in the syngas stream 134. Some of this hydrogen may be consumed in the reverse water-gas shift reaction. In some embodiments, the syngas stream 134 may be purified by removing contents other than hydrogen and carbon monoxide in a purification system 146. For example, the syngas stream 134 may be cooled to remove condensate in a knockout drum, the syngas stream 134 may be subjected to temperature-swing adsorption or pressure-swing adsorption, or any method for separating gases may be used to purify the syngas stream 134. The purified syngas stream 148 may be supplied to a Fisher-Tropsch reactor to produce a mixture of hydrocarbons, which can then be separated and transformed into commercial-grade hydrocarbon fuels, including sustainable aviation fuels. In some embodiments, the at least one sensor 138 may be configured to measure the hydrogen and carbon monoxide levels in the purified syngas stream 148.

Separating carbon dioxide from the flue gas stream 114 using the MCFC 102 may be more energy efficient than traditional methods of separating carbon dioxide and can be performed on small or large scales, for example, based on the number and size of the fuel cells. Hydrogen production using the SOEC 108 may also be more energy efficient than low-temperature electrolysis technologies and does not require precious metal catalysts.

In some embodiments, system 100 may include a carbon dioxide separation system 140. The carbon dioxide separation system 140 may be configured to separate carbon dioxide from gas streams of system 100, for example, the flue gas stream 114 or the SOEC cathode exhaust stream 134, which may include a portion of the carbon dioxide from the SOEC cathode input stream 126 that passes through the SOEC cathode 112 without being electrolyzed to form carbon monoxide. The carbon dioxide in these streams can be separated from the other gases in the carbon dioxide separation system 140 via liquefaction or other separation techniques. The separated carbon dioxide 142 may be stored in one or more storage tanks 144 and can be supplied to the MCFC cathode 104 when the flow of the flue gas stream 114 is stopped or reduced. For example, if the flue gas stream is received from a natural gas power plant, the stored carbon dioxide may be supplied to the MCFC cathode 104 when power demand is low and the power output from the power plant is reduced.

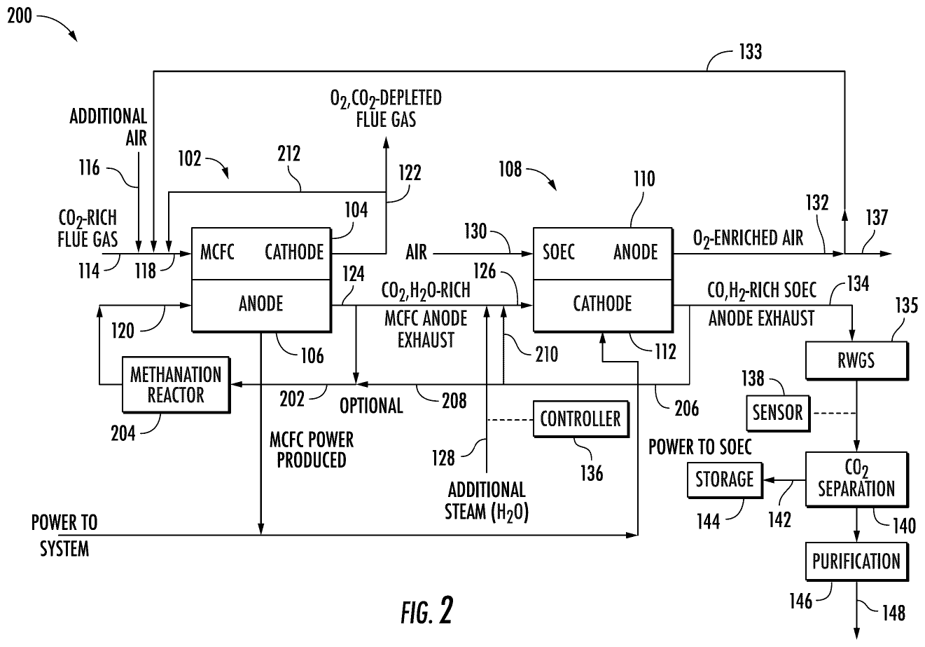

Referring now to FIG. 2, a syngas production system 200 is shown, according to some embodiments. Syngas production system 200 may be substantially similar to syngas production system 100, except as shown and described herein. In system 200, a portion of the MCFC anode exhaust stream 124 may be recycled via a MCFC anode recycle stream 202, which may be supplied to a methanation reactor 204. In addition to the carbon dioxide and carbon monoxide formed in the MCFC anode 106, the MCFC anode exhaust stream 124 may include hydrogen that is formed in the internal reforming reaction in the MCFC anode 106 but passes through the MCFC anode without reacting with carbonate ions to form water. The methanation reactor 204 may react carbon dioxide with hydrogen, as well as carbon monoxide with hydrogen, in the MCFC anode recycle stream 202 to form methane, according to the following formulas:

CO₂+4H₂→CH₄+2H₂O

CO+3H₂→CH₄+H₂O

The methane produced may then be supplied to the MCFC anode 106 via the MCFC anode input stream 120 instead of or in addition to methane supplied from an external source (as shown in FIG. 1). In some embodiments, a portion of the SOEC cathode exhaust stream 134 may be recycled via an SOEC cathode recycle stream 206. In some embodiments, a first portion 208 of the SOEC cathode recycle stream 206 may be mixed with the MCFC anode recycle stream 202 and supplied to the methanation reactor 204 to provide additional hydrogen for the methanation reaction. The carbon monoxide in the first portion 208 of the SOEC cathode recycle stream 206 may also be methanated in the methanation reactor 204. A second portion 210 of the SOEC cathode recycle stream 206 may be mixed with the portion of the MCFC anode exhaust stream 124 that is not recycled and, in some embodiments, the additional steam stream 128 to form the SOEC cathode input stream 126. Unreacted steam or carbon dioxide that passes through the SOEC cathode 112 can thus be recycled via the second portion 210 of the SOEC cathode recycle stream 206 for a second pass through the SOEC cathode 112, where they may react to form hydrogen or carbon monoxide, respectively. In some embodiments, a portion of the MCFC cathode exhaust stream 122 may be recycled via a MCFC cathode recycle stream 212, which may be returned to the input of the MCFC cathode 104 as part of the MCFC cathode input stream 118. Carbon dioxide that passes through the MCFC cathode 104 can thus be recycled via the MCFC cathode recycle stream 212 for a second pass through the MCFC cathode 104, where it may react to form carbonate ions that cross over the electrolyte to the MCFC anode 106.

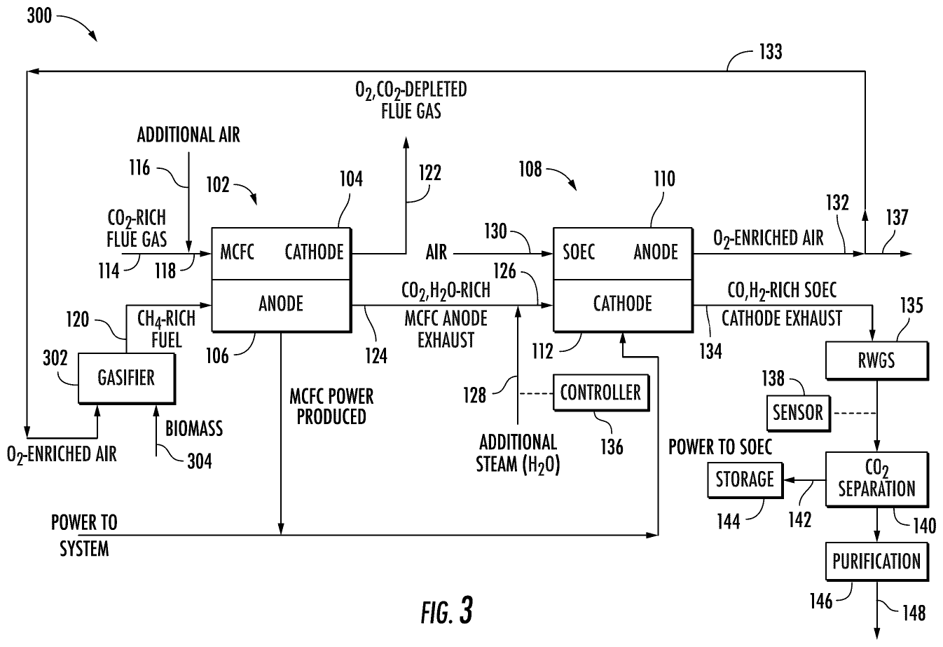

Referring now to FIG. 3, a syngas production system 300 is shown, according to some embodiments. Syngas production system 300 may be substantially similar to syngas production system 100, except as shown and described herein. In syngas production system 300, at least a portion of the SOEC anode exhaust stream 132, which includes air supplied directly to the SOEC anode 110 and oxygen formed in the SOEC anode 110 after oxide ions cross over the electrolyte from the SOEC cathode 112, is supplied to a biomass gasifier 302 via return stream 133. The biomass gasifier 302 also receives biomass 304 (e.g., organic material). In the biomass gasifier 302, biomass 304 undergoes a gasification process and is converted into a gas that includes methane, hydrogen, carbon monoxide, carbon dioxide, and other compounds by applying heat and pressure in the presence of steam and oxygen. The output stream from the biomass gasifier 302 may be used as the MCFC anode input stream 120. Gasification at lower temperatures may result in a higher proportion of methane output from the biomass gasifier 302.

In some embodiments, steam may be supplied to the biomass gasifier 302 instead of or in addition to the oxygen-enriched air in the return stream 133. The addition of steam may cause the output from the biomass gasifier 302 to have a higher concentration of steam, which may eliminate any need to humidify the biomass gasifier 302 output stream before supplying it to the MCFC anode 106.

Heat generated by the net exothermic reactions in the biomass gasifier 302 may be supplied to a boiler, which may generate steam to be supplied to the SOEC cathode 112 (e.g., via the additional steam stream 128). Heat generated by the gasifier may also be used to directly heat the SOEC cathode input stream 126 and/or the SOEC anode input stream 130. The heat energy supplied by the gasifier may be absorbed in the endothermic reactions in the SOEC 108.

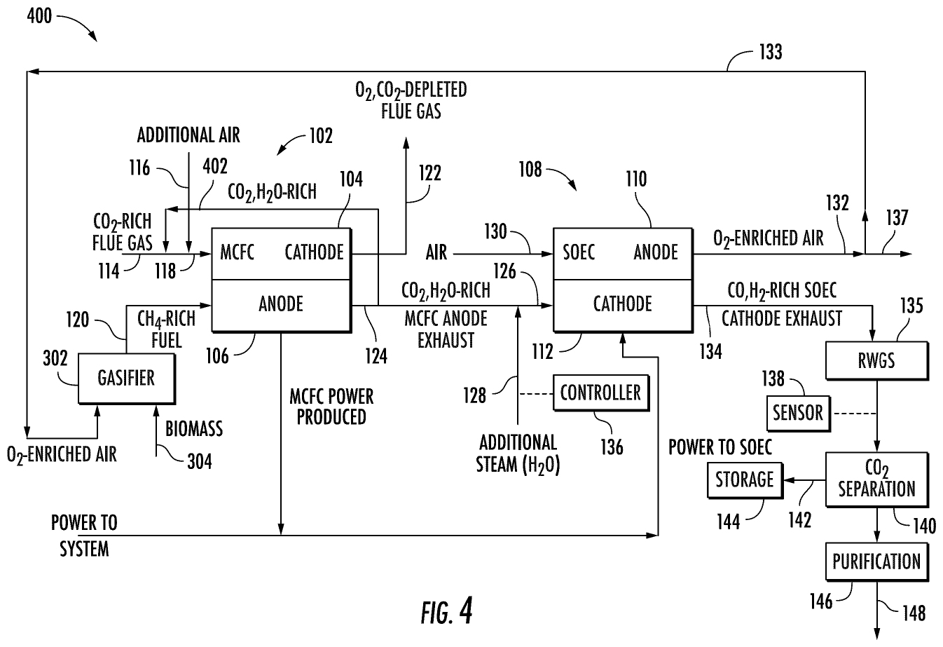

Referring now to FIG. 4, a syngas production system 400 is shown, according to some embodiments. Syngas production system 400 may be substantially similar to syngas production system 300, except as shown and described herein. In addition to the features of syngas production system 300, syngas production system 400 includes a MCFC cathode return stream 402 that directs a portion of the MCFC anode exhaust stream 124 to the MCFC cathode 104. The MCFC cathode return stream 402 may then be combined with the flue gas stream 114 and, in some embodiments, the additional air stream 116 to form the MCFC cathode input stream 118. As discussed above, the MCFC anode exhaust stream 124 is rich in CO₂ and H₂O and may also contain CO. The CO in the MCFC anode exhaust stream 124 may react with air in the presence of an oxidizing catalyst to form additional CO₂, which may increase the current density and electrical power output of the MCFC 102.

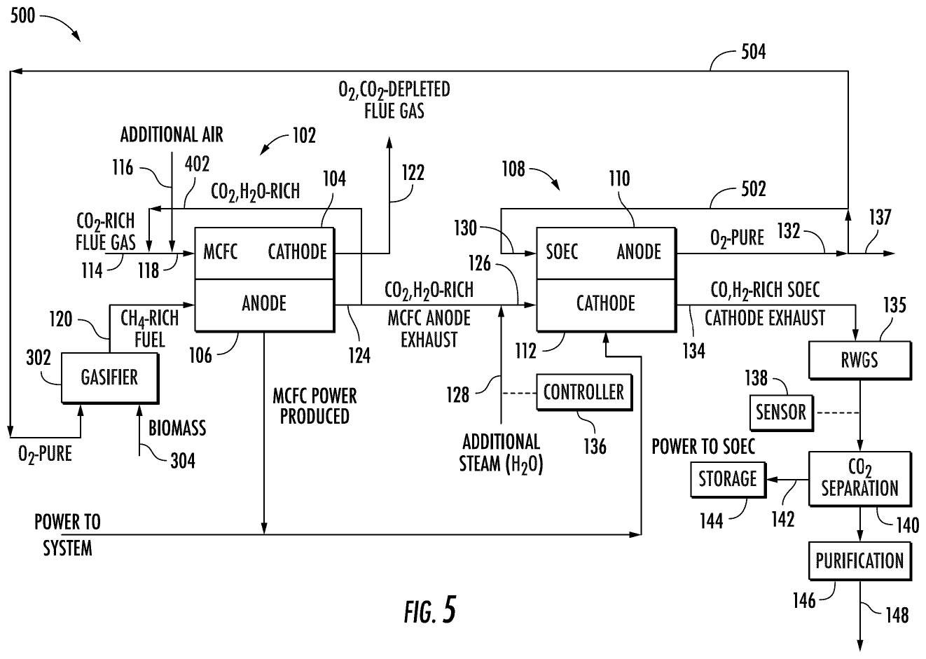

Referring now to FIG. 5, a syngas production system 500 is shown, according to some embodiments. Syngas production system 500 may be substantially similar to syngas production system 400, except as shown and described herein. In addition to the features of syngas production system 400, syngas production system 500 includes an SOEC anode recycle stream 502, which recycles a portion of the SOEC anode exhaust stream 132 to the SOEC anode input stream 130, replacing the air that is input via the SOEC anode input stream 130 in system 400. This may result in an SOEC anode exhaust stream 132 that is substantially pure oxygen gas. Another portion of the SOEC anode exhaust stream 132 may be directed to the gasifier 302 via the return stream 133. The substantially pure oxygen gas in the return stream 133 may improve the efficiency of the gasifier 302 compared to the air and oxygen mixture supplied to the gasifier 302 in systems 300 and 400. In other embodiments, the SOEC anode recycle stream 502 may be combined with an air stream to form the SOEC anode input stream 130, resulting in an SOEC anode exhaust stream 132 with elevated levels of oxygen but not substantially pure oxygen. A portion of the SOEC anode exhaust stream 132 may be exhausted from the system 500 via the exhaust line 137.

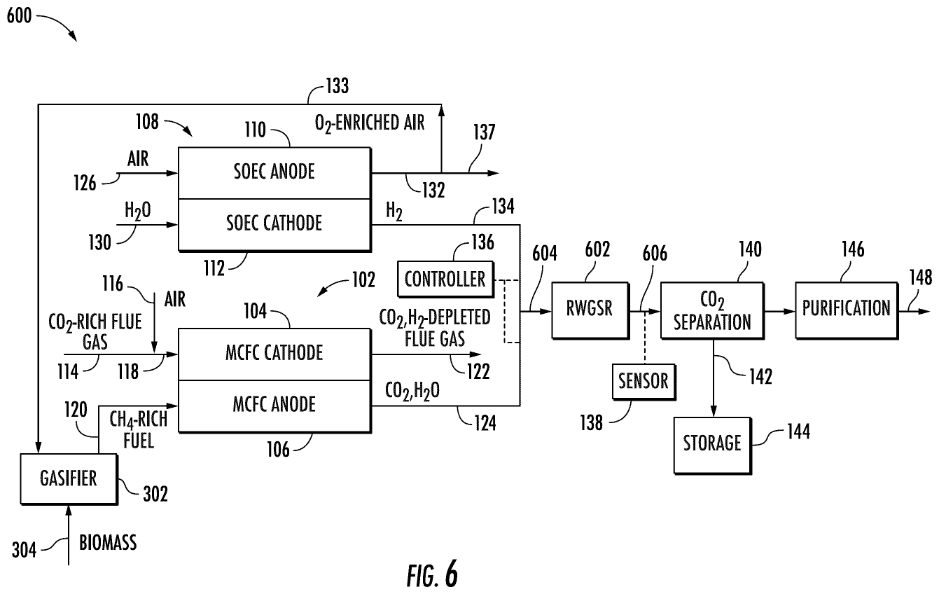

Referring now to FIG. 6, a syngas production system 600 is shown, according to some embodiments. Unlike syngas production system 100, syngas production system 600 includes the MCFC 102 and the SOEC 108 arranged in parallel, rather than in series. In this embodiment, the SOEC cathode 112 not configured to receive the MCFC anode exhaust stream 124. Instead, the SOEC cathode 112 may be configured to receive an SOEC cathode input stream 126 containing steam from another source (e.g., a steam generator, a boiler, etc.). The SOEC 108 may electrolyze the steam and output an SOEC cathode exhaust stream 134 containing hydrogen gas. The MCFC cathode 104 may receive a MCFC cathode input stream 118 including a flue gas stream 114, and the MCFC anode 106 may receive a MCFC anode input stream 120 including methane-rich fuel. The MCFC anode 106 may output a MCFC anode exhaust stream 124 containing carbon dioxide and steam.

The SOEC cathode exhaust stream 134 and the MCFC anode exhaust stream 124 may be combined in a reverse water-gas shift reactor (RWGSR) input stream 604, which may be received by a RWGSR 602. The RWGSR 602 may be configured to subject the RWGSR input stream 604 to a reverse water-gas shift reaction to convert a portion of the hydrogen and at least a portion of the carbon dioxide to carbon monoxide and steam according to the following formula:

CO₂+H₂→CO+H₂O

The RWGSR 602 may then output a RWGSR output stream 606 containing carbon monoxide and hydrogen (i.e., syngas), as well as carbon dioxide and steam. The RWGSR output stream 606 may be directed to a carbon dioxide separation system 140 configured to separate carbon dioxide from the RWGSR output stream 606. As discussed above with respect to system 100, the separated carbon dioxide 142 may be stored in one or more storage tanks 144 for later use, for example, to replace or supplement the flue gas stream 114. The remaining gases in the RWGSR output stream 606 may be purified in a purification system 146 to form a purified syngas stream 148 comprising substantially pure syngas (e.g., a mixture of substantially only carbon monoxide and hydrogen). For example, the RWGSR output stream 606 may be cooled to remove condensate in a knockout drum, the RWGSR output stream 606 may be subjected to temperature-swing adsorption or pressure-swing adsorption to remove gases other than carbon monoxide and hydrogen, or any method for separating gases may be used to purify the RWGSR output stream 606 to remove gases other than carbon monoxide and hydrogen. The purified syngas stream 148 may be supplied to a Fisher-Tropsch reactor to produce a mixture of hydrocarbons, which can then be separated and transformed into commercial-grade hydrocarbon fuels, including sustainable aviation fuels.

In system 600, as in systems 300, 400, 500, at least a portion of the SOEC anode exhaust stream 132 containing oxygen-enriched air may be supplied to a gasifier 302 via return stream 133 and used to gasify biomass 304 to produce a methane-rich fuel stream that can be input into the MCFC anode 106 as MCFC anode input stream 120. The gasifier 302 may also produce heat that may be supplied to a boiler to generate steam for the SOEC cathode input stream 126. System 600 may also include recycle and return streams similar to those shown and described with respect to systems 200, 300, 400, 500. For example, a portion of the MCFC anode exhaust stream 124 may be directed to the MCFC cathode input stream 118 and/or a portion of the SOEC anode exhaust stream 132 may be recycled to the SOEC anode input stream 130. Accordingly, system 600 may be substantially similar to systems 100, 200, 300, 400, 500 but may generate syngas using the RWGSR 602, with the SOEC 108 and the MCFC 102 in parallel, rather than the MCFC 102 and the SOEC 108 being arranged in series and the syngas being generated in the SOEC 108. System 600 may further include a controller 136 configured to control the flow rates of the SOEC cathode exhaust stream 134 and the MCFC anode exhaust stream 124 into the RWGSR input stream 604. System 600 may include at least one sensor 138 communicatively coupled to the controller 136 and configured to measure the hydrogen and carbon monoxide levels in the RWGSR output stream 606. The controller 136 may adjust the amount of additional steam supplied based on the measurements from the at least one sensor 138 in order to achieve a predetermined target ratio of hydrogen to carbon monoxide in the RWGSR output stream 606. In some embodiments, the at least one sensor 138 may be configured to measure the hydrogen and carbon monoxide levels in the purified syngas stream 148.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the Figures. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention. For example, the heat recovery heat exchangers may be further optimized.

The hardware and data processing components used to implement the various processes, operations, illustrative logics, logical blocks, modules and circuits described in connection with the embodiments disclosed herein (e.g., the controller 136) may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the controller may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device may be communicably connected to the processor to provide computer code or instructions to the processor for executing at least some of the processes described herein. Moreover, the memory device may be or include tangible, non-transient volatile memory or non-volatile memory. Accordingly, the memory device may include database components, object code components, script components, or any other type of information structure for supporting the various activities and information structures described herein.

What is claimed is:

1. A syngas generation system comprising:
a molten carbonate fuel cell (MCFC) comprising a MCFC cathode configured to receive a MCFC cathode input stream comprising a flue gas stream and a MCFC anode configured to output a MCFC anode exhaust stream comprising carbon dioxide and steam; and
a solid oxide electrolysis cell (SOEC) comprising an SOEC cathode and an SOEC anode, the SOEC configured to:
receive, at the SOEC cathode, an SOEC cathode input stream, the SOEC cathode input stream comprising at least a portion of the MCFC anode exhaust stream;
co-electrolyze carbon dioxide and steam in the SOEC cathode input stream; and
output, from the SOEC cathode, an SOEC cathode exhaust stream comprising carbon monoxide and hydrogen gas.

2. The syngas generation system of claim 1, further comprising a controller configured to control a flow rate of additional steam into the SOEC cathode input stream based on a predetermined target ratio of carbon monoxide to hydrogen gas in the SOEC cathode exhaust stream.

3. The syngas generation system of claim 1, wherein the SOEC is configured to receive electrical power produced by the MCFC.

4. The syngas generation system of claim 1, further comprising a methanation reactor configured to:
receive a portion of the MCFC anode exhaust stream;
methanate the portion of the MCFC anode exhaust stream; and
output a methanated exhaust stream to the MCFC anode.

5. The syngas generation system of claim 4, wherein the methanation reactor is further configured to receive and methanate a first portion of the SOEC cathode exhaust stream.

6. The syngas generation system of claim 4, wherein the SOEC cathode input stream further comprises a second portion of the SOEC cathode exhaust stream.

7. The syngas generation system of claim 1, wherein the SOEC anode is configured to output an SOEC anode exhaust stream comprising oxygen gas, the syngas generation system further comprising a gasifier configured to:
receive at least a first portion of the SOEC anode exhaust stream;
gasify biomass using the SOEC anode exhaust stream; and
output a gasified exhaust stream to the MCFC anode.

8. The syngas generation system of claim 7, wherein the MCFC cathode input stream comprises a portion of the MCFC anode exhaust stream.

9. The syngas generation system of claim 7, wherein the SOEC anode is configured to receive a second portion of the SOEC anode exhaust stream.

10. The syngas generation system of claim 1, wherein the SOEC is configured to receive heat generated by the MCFC.

11. A method of producing syngas using a molten carbonate fuel cell (MCFC) and a solid oxide electrolysis cell (SOEC), the method comprising:
supplying a flue gas stream to a MCFC cathode of the MCFC, the MCFC configured to output a MCFC anode exhaust stream comprising carbon dioxide and steam from an MCFC anode; and
supplying an SOEC cathode input stream to an SOEC cathode of the SOEC, the SOEC cathode input stream comprising at least a portion of the MCFC anode exhaust stream, the SOEC configured to co-electrolyze carbon dioxide and steam in the SOEC cathode input stream and to output an SOEC cathode exhaust stream comprising carbon monoxide and hydrogen gas.

12. The method of claim 11, further comprising supplying additional steam to the SOEC cathode input stream, wherein an amount of the additional steam supplied to the SOEC cathode exhaust stream is determined based on a predetermined target ratio of carbon monoxide to hydrogen gas in the SOEC cathode exhaust stream.

13. The method of claim 11, further comprising supplying power generated by the MCFC to the SOEC.

14. The method of claim 11, further comprising methanating a portion of the MCFC anode exhaust stream and supplying methanated exhaust to the MCFC anode.

15. The method of claim 14, further comprising methanating a first portion of the SOEC cathode exhaust stream, the methanated exhaust comprising methanated SOEC cathode exhaust.

16. The method of claim 14, further comprising supplying a second portion of the SOEC cathode exhaust stream to the SOEC cathode input stream.

17. The method of claim 11, further comprising:
gasifying biomass using at least a first portion of an SOEC anode exhaust stream from an SOEC anode of the SOEC; and
supplying a gasified exhaust stream to the MCFC anode.

18. The method of claim 17, further comprising supplying a portion of the MCFC anode exhaust stream to the MCFC cathode.

19. A syngas generation system comprising:
a molten carbonate fuel cell (MCFC) comprising a MCFC cathode and an MCFC anode configured to output a MCFC anode exhaust stream comprising carbon dioxide;
a solid oxide electrolysis cell (SOEC) comprising an SOEC anode and an SOEC cathode configured to output an SOEC cathode exhaust stream comprising hydrogen gas; and
a reverse water-gas shift reactor (RWGSR) configured to receive a RWGSR input stream comprising at least a portion of the MCFC anode exhaust stream and at least a portion of the SOEC cathode exhaust stream, the RWGSR configured to output a RWGSR output stream comprising hydrogen and carbon monoxide.

20. The syngas generation system of claim 19, further comprising a controller configured to control a first flow rate of the at least the portion of the MCFC anode exhaust stream and a second flow rate of the at least the portion of the SOEC cathode exhaust stream into the RWGSR input stream, wherein the controller is configured to control the first flow rate and the second flow rate based on a predetermined target ratio of carbon monoxide to hydrogen gas in the RWGSR output stream.
